(19) United States
(12) Patent Application Publication
(10) Pub. No.: US 2008/0002246 A1
(43) Pub. Date: Jan. 3, 2008

(54) LASER SCANNING UNIT AND IMAGE FORMING APPARATUS INCLUDING THE SAME

(75) Inventor: Jong-wuk KU, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/682,522

(22) Filed: Mar. 6, 2007

(30) Foreign Application Priority Data
Jun. 29, 2006 (KR) 2006-59877

(51) Int. Cl. G02B 26/08

(52) U.S. Cl. 359/204; 359/206

(57) ABSTRACT

A laser scanning unit including a polygon mirror which has a plurality of reflecting faces reflecting an incident light onto a predetermined image forming part and is rotatably operated, a first light source scanning a first laser onto the reflecting faces at a predetermined scanning angle with respect to a centering line connecting a rotating axial line of the polygon mirror with a predetermined reference position on the image forming part, a second light source scanning a second laser symmetrical with the first laser with respect to the centering line onto the reflecting faces, a first Fθ lens which is positioned on the first optical path between the image forming part and the polygon mirror, and a second Fθ lens which is positioned on the second optical path between the image forming part and the polygon mirror, and has an optical characteristic symmetrical with the first Fθ with respect to the centering line.

### CROSS-REFERENCE TO RELATED APPLICATIONS

This application claims priority to Korean Patent Application No. 2006-0059877, filed on Jun. 29, 2006, the disclosure of which is incorporated herein by reference in its entirety.

### BACKGROUND OF THE INVENTION

1. Field of the Invention

The present general inventive concept relates to a laser scanning unit and an image forming apparatus. More particularly, to a multi-beam type laser scanning unit with reduced size and reduced manufacturing cost, and an image forming apparatus including the laser scanning unit.

2. Description of the Related Art

In general, a laser scanning unit (LSU) scans a laser beam onto a surface of a photosensitive body to form an electrostatic latent image in an electrophotographic image forming apparatus such as a laser printer, a copier and the like. There is a single-beam type laser scanning unit using a single light source, however, a multi-beam type laser scanning unit using a plurality of laser sources corresponding to a plurality of colors has been in use which can be scanned at the same time in a colored image forming apparatus.

As shown in FIG. 1, a laser scanning unit 10 having the conventional multi-beam type contains a polygon mirror 17 which rotates at a uniform speed and reflects light, and a plurality of photosensitive bodies 19a and 19b positioned opposite each other across the polygon mirror 17. Between the polygon mirror 17 and the photosensitive bodies 19a and 19b are positioned F-θ lenses 18a and 18b, respectively, that form an image from the light reflected by the polygon mirror 17 onto the surfaces of the photosensitive bodies 19a and 19b, respectively. The two F-θ lenses 18a and 18b have the same shape. A first light source 11a and a second light source 11b scan two laser lights symmetrically with respect to a line K that passes a rotation center of the polygon mirror 17 and that is parallel to the photosensitive bodies 19a and 19b (refer to FIG. 1). Further, the scanned laser lights pass through the collimating lenses 13a and 13b and a cylindrical lens 15 on their respective optical paths, and are then concentrated into a linear beam. The concentrated beam is reflected by the polygon mirror 17, refracted by the respective F-θ lenses 18a and 18b and then scanned onto the surfaces of the photosensitive bodies 19a and 19b in a predetermined range (See W in FIG. 1).

However, the conventional laser scanning unit 10 is configured to where the light sources 11a and 11b are symmetrically positioned with respect to the line K in FIG. 1. Accordingly, because the photosensitive bodies 19a and 19b must be positioned to be symmetrical with each other with respect to the line K, more space is used than may be necessary. For example, when the light sources 11a and 11b and the photosensitive bodies 19a and 19b are positioned to one side, the laser scanning unit 10 and the image forming apparatus can be more compactly arranged.

As an example, it may be assumed that the light sources 11a and 11b are positioned to be symmetrical to each other with respect to an arbitrary line L in place of the line K in FIG. 1 in an attempt to improve its efficiency of space.

However, in the case that the light sources 11a and 11b are positioned as in the above-described method, the laser scanning range in the main scanning direction (a transverse direction of a printing paper) on the respective surfaces of the photosensitive bodies 19a and 19b become misaligned with each other. That is, opposite ends of the laser scanning range formed in a photosensitive body 19a are misaligned with those of the laser scanning range formed in the photosensitive body 19b. When the scanning ranges are misaligned, electrostatic latent image areas formed in the respective photosensitive bodies 19a and 19b become misaligned with each other. In particular, in the case of a colored image obtained by mixing the electrostatic latent images corresponding to predetermined colors, the formed colored image may be distorted and may not have the user-desired color.

Accordingly, the F-θ lenses corresponding to the light sources 11a and 11b should be designed to prevent the distortion. Therefore, the F-θ lenses 19a and 19b which are of the same shape, as shown in FIG. 1, can not be used, thereby increasing the manufacturing cost of the laser scanning unit 10.

### SUMMARY OF THE INVENTION

The present general inventive concept provides a multi-beam type laser scanning unit that has an enhanced spatial arrangement and reduces manufacturing costs, and an image forming apparatus including the same.

Additional aspects and utilities of the present general inventive concept will be set forth in part in the description which follows and, in part, will be obvious from the description, or may be learned by practice of the general inventive concept.

The foregoing and other aspects and utilities of the general inventive concept are achieved by providing a laser scanning unit containing, a rotatably operatable polygon mirror with a plurality of reflecting faces to reflect an incident light onto an image forming part, a first light source to scan a first laser onto the reflecting faces at a predetermined scanning angle with respect to a center line that passes through a rotating axial line of the polygon mirror and a predetermined reference position on the image forming part, a second light source to scan a second laser onto the reflecting faces, the second laser being symmetrical to the first laser with respect to the center, a first F-θ lens positioned on a first optical path of the first laser between the image forming part and the polygon mirror, and a second F-θ lens positioned on a second optical path of the second laser between the image forming part and the polygon mirror, the second F-θ lens having an optical characteristic symmetrical to the first F-θ lens with respect to the center line.

Each scanning angle of the first laser and the second laser can be an acute angle.

The first laser and the second laser can be scanned onto a target position on the center line shifted at a predetermined distance from the rotating axial line toward the image forming part.

The first F-θ lens and the second F-θ lens can be shifted a predetermined offset amount along a main scanning direction from the center line.

The first laser and the second laser can be displaced from each other along a direction of the rotating axial line and scanned onto the reflecting faces.

The laser scanning unit may further contain an additional light source which is symmetrical with at least one of the first laser and the second laser with respect to the center line and scans at least one additional laser onto the reflecting faces, the additional light source being spaced from the at least one of the first laser and second laser along the rotating axial line, and an additional F-θ lens which is positioned on an additional optical path between the image forming part and the polygon mirror, the additional F-θ lens has an optical characteristic symmetrical with at least one of the F-θ lens.

The predetermined offset amount H can be within the range of the following formula:

$$2 d tan ( θ ) ≦ H ≦ 2 r sin ( \frac{180}{n} )$$

where, “d” indicates a perpendicular distance between the lens center and the image forming part, “θ” indicates a space angle between a line connecting a lens center with the reference position and the center line, “r” indicates an inscribed circle radius of the reflecting faces of the polygon mirror, and “n” indicates a number of the reflecting faces of the polygon mirror.

The laser scanning unit may further contain an additional light source symmetrically positioned to at least one of the first light source and the second light source with respect to a center cross line which passes through the rotating axial line and is at a right angle to the center line, and an additional F-θ lens positioned between the polygon mirror and another image forming part, the another image forming part being symmetrically positioned with the image forming part with respect to the center cross line, and the additional F-θ lens being arranged to be symmetrical with at least one of the first F-θ lens and the second F-θ lens with respect to the center cross line.

The foregoing and other aspects and utilities of the general inventive concept are also achieved by providing an image forming apparatus containing, an image forming part, a rotatably operatable polygon mirror with a plurality of reflecting faces to reflect an incident laser, a first light source to scan a first laser onto the reflecting faces at a predetermined scanning angle with respect to a center line that connects a rotating axial line of the polygon mirror with a predetermined reference position of the image forming part, a second light source to scan a second laser onto the reflecting faces, the second laser being symmetrical to the first laser with respect to the center line, a first F-θ lens positioned on a first optical path of the first laser between the image forming part and the polygon mirror, and a second F-θ lens positioned on a second optical path between the image forming part and the polygon mirror, the second F-θ lens having an optical characteristic that is symmetrical with the first F-θ lens with respect to the center line.

The first laser and the second laser can be scanned onto a target position which is shifted a predetermined distance from the axial line to the image forming part along the center line.

The first F-θ lens and the second F-θ lens can be shifted a predetermined offset amount along a main scanning distance from the center line.

The predetermined offset amount H is within the range of the following formula:

$$2 d tan ( θ ) ≦ H ≦ 2 r sin ( \frac{180}{n} )$$

where, “d” indicates a perpendicular distance between the lens center and the image forming part, “θ” indicates an angle between a line connecting a lens center with the reference position and the center line, “r” indicates an inscribed circle radius of the reflecting faces of the polygon mirror, and “n” indicates the number of a reflecting faces of the polygon mirror.

The image forming apparatus may further contain another image forming part positioned to be symmetrical with the image forming part with respect to a cross line which passes through the rotating axial line and is at a right angle to the center line, another light source positioned to be symmetrical with at least one of the first light source and the second light source with respect to the center cross line, and another F-θ lens positioned between the another image forming part and the polygon mirror, and symmetrical with at least one of the first F-θ lens and the second F-θ lens with respect to the center cross line.

The foregoing and other aspects and utilities of the general inventive concept are also achieved by providing a laser scanning unit including a rotatable polygon mirror with a plurality of reflecting faces to reflect an incident light onto at least one image forming part, at least one pair of light sources each corresponding to a respective image forming part to scan a pair of lasers onto the reflecting faces symmetrically to each other with respect to a center line extending between a rotating axial line of the polygon mirror and a predetermined reference position on a respective one of the image forming parts, and a pair of F-θ lenses corresponding to each pair of light sources, each F-θ lens being disposed along an optical path of a corresponding laser of the pair of lasers between the corresponding respective image forming part and the polygon mirror.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plane view illustrating a laser scanning unit of a conventional multi-beam type;

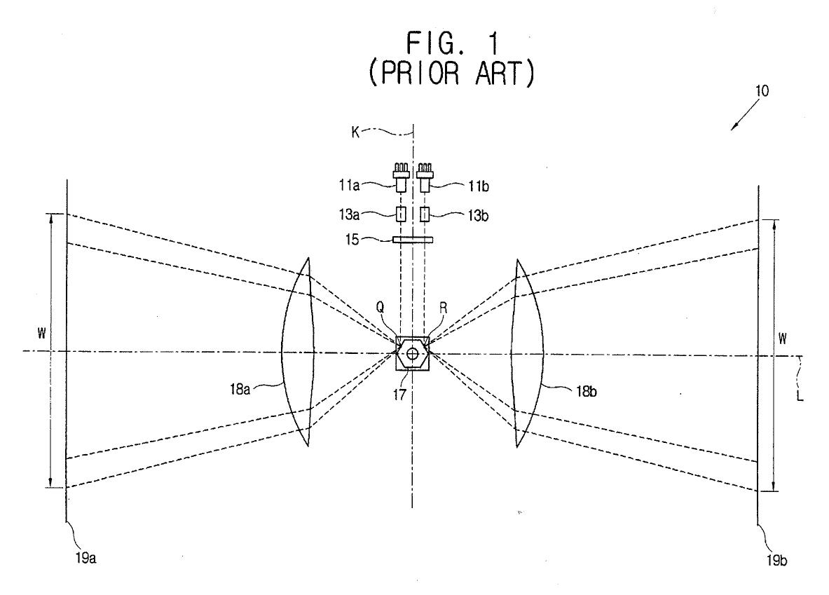

FIG. 2 is a plane view of a laser scanning unit according to an embodiment of the present general inventive concept;

FIG. 3 is a plane view illustrating a configuration of a F-θ lens of the laser scanning unit in FIG. 2;

FIG. 4 is a partial enlarged view of the laser scanning unit in FIG. 2;

FIG. 5 is a perspective view of another laser scanning unit according to an embodiment of the present general inventive concept;

FIG. 6 is a plane view of the laser scanning unit in FIG. 5; and

FIG. 7 is a sectional view of an image forming apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

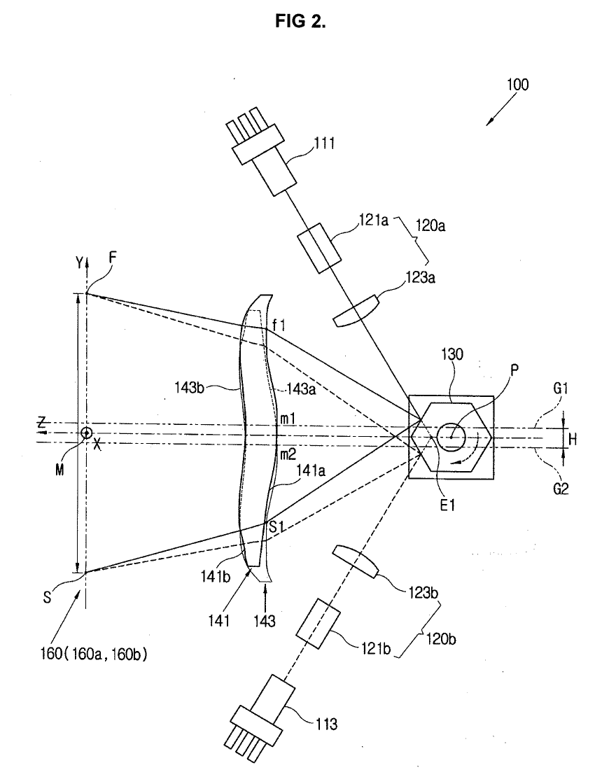

As shown in FIG. 2, in a laser scanning unit 100 according to an embodiment of the present general inventive concept, a first laser (see solid line in FIG. 2) and a second laser (see dotted line in FIG. 2) are scanned symmetrically to each other with respect to an arbitrary center line (see Z axis in FIG. 2) from a first light source 111 and a second light source 113, respectively, and the first laser and the second laser pass through optical lens 120a and 120b, respectively, provided on the respective optical paths to be converted into a linear-type laser of a sub scanning direction (a lengthwise direction of a printing paper). The converted lasers are reflected from reflecting faces of a polygon mirror 130 rotating at a uniform speed, and then reflected to a first F-θ lens 141 and a second F-θ lens 143, respectively. The first F-θ lens 141 and the second F-θ lens 143 focus the incident laser in a main scanning direction and respectively expose surfaces of image forming parts 160a and 160b to form an electrostatic latent image within a predetermined scanning range (see S to F in FIG. 2).

As shown in FIG. 2, the image forming part 160 is provided as a plurality of photosensitive bodies 160a and 160b in which electrostatic latent images are formed by the light sources 111 and 113. The image forming part 160 may be provided as a photosensitive body in the case that a laser is scanned onto different surfaces of the photosensitive bodies 160a and 160b. As necessary, the image forming part 160 may contain a reflection mirror capable of changing an optical path toward a photosensitive body placed in a predetermined position.

The first light source 111 and the second light source 113 scan their respective lasers onto the reflecting surfaces of the polygon mirror 130 symmetrically with each other at a predetermined scanning angle with respect to the center line (Z axis in FIG. 2). Here, the center line (Z axis) connects a rotating axial line (perpendicular to the direction of the plane of FIG. 2 and at point P) of the polygon mirror 130 with a reference position (See M in FIG. 2) of the image forming part 160. The reference position may be arbitrarily set, but it is desirable to have it set as a center point (M in FIG. 2) of a range in which the laser is scanned in the main scanning direction, to minimize an unnecessary area in which an electrostatic latent image is not formed in the image forming part 160.

The first light source 111 and the second light source 113 are preferably, but not necessarily, positioned to scan the laser at an acute angle with respect to the center line (Z axis). Also, they may be positioned to scan the laser at a right angle or an obtuse angle with respect to the center line (Z axis), as necessary.

The first light source 111 and the second light source 113 scan the laser onto a target position (E1) that is shifted from the rotating axial line (point P) of the polygon mirror 130 to the image forming part 160 by a predetermined distance. Here, the target position (E1) is located on the center line (Z axis), and may be adjusted within a range in which the laser scanned by the plurality of light sources 111 and 113 can be reflected by the reflecting faces of the polygon mirror 130.

The first light source 111 and the second light source 113 are provided as laser diodes, however LEDs or other known radiating elements may be used. The first light source 111 and the second light source 113 may be oriented in the direction of the rotating axial line (point P) of the polygon mirror 130 in consideration of space efficiency to scan the laser onto reflecting faces of the polygon mirror 130.

The first light source 111 and the second light source 113 can operate simultaneously to scan a first laser and a second laser by a controller (not shown). Alternatively, after a predetermined time has passed from when the first light source 111 starts to scan the laser, the second light source 113 can start to scan the laser. Conversely, after the second light source 113 starts to scan the laser, the first light source 111 can start to scan the laser.

The optical lenses 120a and 120b may contain collimating lenses 121a and 121b, respectively, changing the lasers scanned from the first light source 111 and the second light source 113 into lasers parallel with the laser axis or into a converging laser, and the cylindrical lenses 123a and 123b making the lasers which passed through the collimating lenses 121a and 121b into a linear type of the sub scanning direction onto the reflecting faces of the polygon mirror 130. The optical lenses 120a and 120b are provided as a plurality of lenses on the optical paths of the incident laser from each light source 111 or 113 to the polygon mirror 130.

The polygon mirror 130 is shown as having hexagonal reflecting faces, although an alternative mirror shape maybe used, according to design preferences. Also, the number of the reflecting faces may be adjusted as necessary. The polygon mirror 130 may be operated by a motor (not shown) rotating at a uniform speed.

The first F-θ lens 141 and the second F-θ lens 143 are positioned on the respective optical paths between the image forming part 160 and the polygon mirror 130 and converge the first laser and the second laser reflected from the polygon mirror 130 in the main scanning direction to be scanned onto the respective photosensitive bodies 160a and 160b within a predetermined range (see S to F in FIG. 2).

The first F-θ lens 141 and the second F-θ lens 143 are preferably, but not necessarily, injection-molded of a plastic material to enhance productivity and reduce manufacturing cost. Of course, other materials or methods may be employed, as desired. The first F-θ lens 141 and the second F-θ lens 143 are preferably, but not necessarily, disposed in an “up” and “down” orientation, respectively, with respect to the direction of the rotating axial line (perpendicular direction to the plane of FIG. 2 at point P) in consideration of light source arrangement and space efficiency.

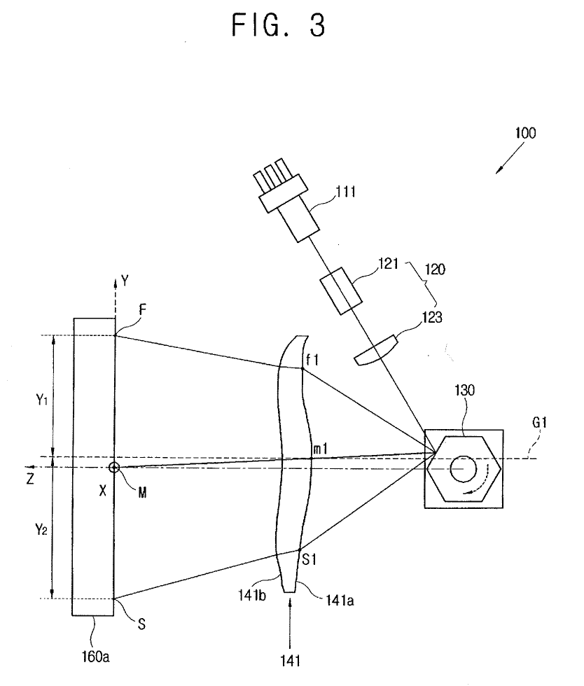

As shown in FIGS. 2 and 3, the first F-θ lens 141 and the second F-θ lens 143 contain incident faces 141a and 143a, respectively, which reflected lasers from the polygon mirror 130 enter and exiting faces 141b and 143b from which the lasers exit.

Hereinafter, a configuration of the incident face 141a and the exiting face 141b of the first F-θ lens 141 will be described.

As shown in FIG. 3, it may be assumed that the polygon mirror 130 may rotate clockwise and a laser is scanned from the first light source 111. The laser passes through point s1 of the incident face 141a of the first F-θ lens 141 to converge onto starting point S within the scanning range of the image forming part 160a, and passes through lens center m1 and point f1 of the incident face 141a which, respectively, converge to center point M and end point F within the scanning range of the image forming part 160a. Here, the incident surface 141a and the exit surface 141b of the first F-θ lens 141 are bridged by center point m1 of the incident surface 141a so that the starting point S and the ending point F can be asymmetrical with each other with respect to line G1 that is parallel to the center line (Z axis). That is, the first F-θ lens 141 has an incident surface 141a and an exit surface 141b having a predetermined SAG value (the depth of a lens surface from a reference point) which makes an upper scanning range Y1 and a sub scanning range Y2 different from each other.

The SAG value of the incident surface 141a and the exit surface 141b of the first F-θ lens 141 may be formed, for example, by Formula 1 and a Table 1 as shown below:

$$z = \frac{{C}_{1} {\vert y \vert}^{2}}{1 + \sqrt{1 - ( 1 + K ) {C}_{1}^{2} {\vert y \vert}^{2}}} + {\sum }_{n = 3}^{10} {A}_{n} {\vert y \vert}^{2} + \frac{{C}_{2} ( 1 + {\sum }_{n = 3}^{10} {B}_{n} {\vert y \vert}^{n} ) {x}^{2}}{1 + \sqrt{1 - {{C}_{2}^{2} ( 1 + {\sum }_{n = 3}^{10} {B}_{n} {\vert y \vert}^{n} )}^{2} {x}^{2}}} \qquad [ Formula 1 ]$$

Here, “z” indicates the depth of the lens surface with respect to the light traveling direction, “y” indicates a lens coordinate of the main scanning direction, and “x” indicates a lens coordinate of a sub scanning direction. “C1” indicates a curvature of the main scanning direction, “C2” indicates a curvature of the sub scanning direction, and “K” indicates an aspheric coefficient. “An” and “Bn” indicate coefficient values which can be selected according to a desired condition, respectively.

| Incident face | | | | Exiting face | | | |
|---|---|---|---|---|---|---|---|
| Y > 0 | | Y < 0 | | Y > 0 | | Y < 0 | |
| C1 | | 7.51e−03 | | C1 | | −5.09e−04 | |
| K | 0.00e+00 | K | 0.00e+00 | K | 0.00e+00 | K | 0.00e+00 |
| A3 | 1.41e−04 | A3 | 1.58e−04 | A3 | 1.59e−04 | A3 | 1.74e−04 |
| A4 | 2.01e−05 | A4 | −2.10e−05 | A4 | −2.11e−05 | A4 | −2.15e−05 |
| A5 | 1.10e−06 | A5 | 1.13e−06 | A5 | 1.25e−06 | A5 | 1.24e−06 |
| A6 | −3.65e−08 | A6 | −3.66e−08 | A6 | −4.71e−08 | A6 | −4.67e−08 |
| A7 | 7.10e−10 | A7 | 7.05e−10 | A7 | 1.15e−09 | A7 | 1.15e−09 |
| A8 | −7.56e−12 | A8 | −7.58e−12 | A8 | −1.84e−11 | A8 | −1.84e−11 |
| A9 | 3.66e−14 | A9 | 4.00e−14 | A9 | 1.75e−13 | A9 | 1.74e−13 |
| A10 | −4.74e−17 | A10 | −7.43e−17 | A10 | −7.68e−16 | A10 | −7.42e−16 |
| C2 | −5.36e−02 | C2 | −5.36e−02 | C2 | −7.82e−02 | C2 | −7.82e−02 |
| B3 | −2.01e−05 | B3 | −5.09e−05 | B3 | −1.05e−05 | B3 | −2.56e−05 |
| B4 | −7.45e−07 | B4 | 4.16e−07 | B4 | 2.72e−07 | B4 | 1.65e−06 |
| B5 | 8.23e−08 | B5 | 1.01e−07 | B5 | 1.66e−08 | B5 | −5.39e−08 |
| B6 | −1.61e−09 | B6 | −3.33e−09 | B6 | −1.23e−09 | B6 | 9.03e−10 |
| B7 | −1.61e−12 | B7 | 3.07e−11 | B7 | 3.19e−11 | B7 | −1.37e−12 |
| B8 | 2.35e−13 | B8 | 2.15e−14 | B8 | −2.01e−13 | B8 | −9.57e−14 |
| B9 | −2.63e−16 | B9 | −3.71e−17 | B9 | −5.02e−15 | B9 | −1.26e−15 |
| B10 | −6.09e−18 | B10 | −9.81e−18 | B10 | 6.87e−17 | B10 | 2.93e−17 |

As shown in FIG. 2, the second F-θ lens 143 has an optical characteristic that is symmetrical to the first F-θ lens 141 with respect to the center line (Z axis). That is, the second F-θ lens 143, when rotated 180 degrees with respect to the center line (Z axis), is optically symmetrical to the first F-θ lens 141.

As described above, the first F-θ lens 141 is manufactured to able to be used as the second F-θ lens 143, and conversely, the second F-θ lens 143 is designed so it can also be used as the first F-θ lens 141.

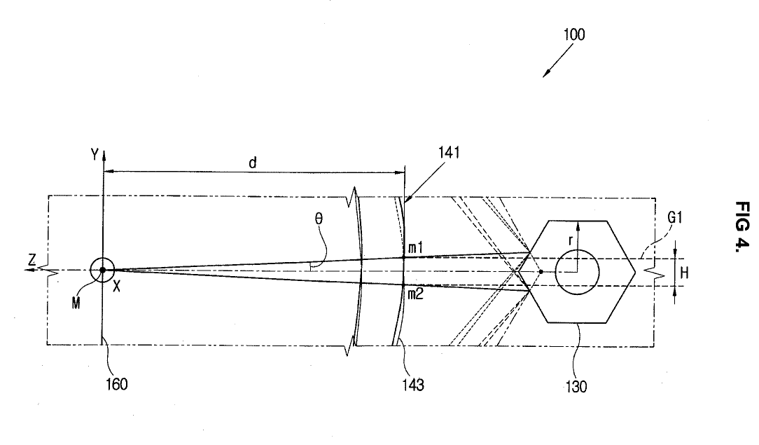

Here, as shown in FIGS. 2 and 4, the first F-θ lens 141 and the second F-θ lens 143 can be shifted as much as a predetermined offset amount H along the main scanning direction with respect to the center line (Z axis). That is, the offset amount H between the lens center (See m1 in FIG. 2) of the first F-θ lens 141 and the lens center (See m2 in FIGS. 2 and 4) of the second F-θ lens 143 exists within a range based on the following Formula 2:

$$2 d tan ( θ ) ≦ H ≦ 2 r sin ( \frac{180}{n} ) \qquad [ Formula 2 ]$$

Here, “d” indicates a perpendicular distance from the lens center m1 of the first F-θ lens 141 to the image forming part 160a, and “θ” indicates an angle between the line connecting the lens center m1 of the first F-θ lens 141 with a reference position M of the image forming part 160a, and the center line (Z axis). “r” indicates an inscribed circle radius of the reflecting faces of the polygon mirror 130, and “n” indicates the number of reflecting faces of the polygon mirror 130.

Although the laser scanning unit 100 is shown in FIG. 2 with light sources 111 and 113 positioned to scan the symmetrical lasers with respect to the center line (Z axis), the opposite ends of the laser scanning range formed in the image forming part 160 may be coincident with each other since the second F-θ lens 143 has optical characteristics symmetrical to that of the first F-θ lens 141, with respect to the center line (Z axis).

Accordingly, the second F-θ lens 143 does not need to be separately designed and manufactured. Rather, only the first F-θ lens 141 may be designed and manufactured and used as the second F-θ lens 143, thereby reducing manufacturing costs.

Also, the light sources 111 and 113 may be positioned as shown in FIG. 2, thereby enhancing space efficiency.

The laser scanning unit 100 may further contain an additional light source (not shown) which is symmetrical with at least one of the first laser and the second laser with respect to the center line (Z axis), and scans an additional laser spaced along the rotating axial line (the line which passes the point P in FIG. 2 and is perpendicular to the plane of FIG. 2) of the polygon mirror 130, and an additional F-θ lens (not shown) positioned on an additional optical path between the image forming part 160 and the polygon mirror 130, as necessary.

The additional light source (not shown) scans the additional laser, which is symmetrical with one of the first laser or the second laser with respect to the center line (Z axis) and onto the reflecting faces of the polygon mirror 130 spaced along the rotating axial line. The additional light source (not shown) may be provided as a plurality of light sources as necessary.

The additional F-θ lens (not shown) has an optical characteristic symmetrical to the first F-θ lens 141 or the second F-θ lens 142 with respect to the center line (Z axis). The additional F-θ lens (not shown) may also be spaced from the first F-θ lens 141 or second F-θ lens 143 along the rotating axial line (perpendicular to the plane of FIG. 2 at point P).

Accordingly, a plurality of light sources can be all positioned between the image forming part 160 and the polygon mirror 130, to improve the utilization of space.

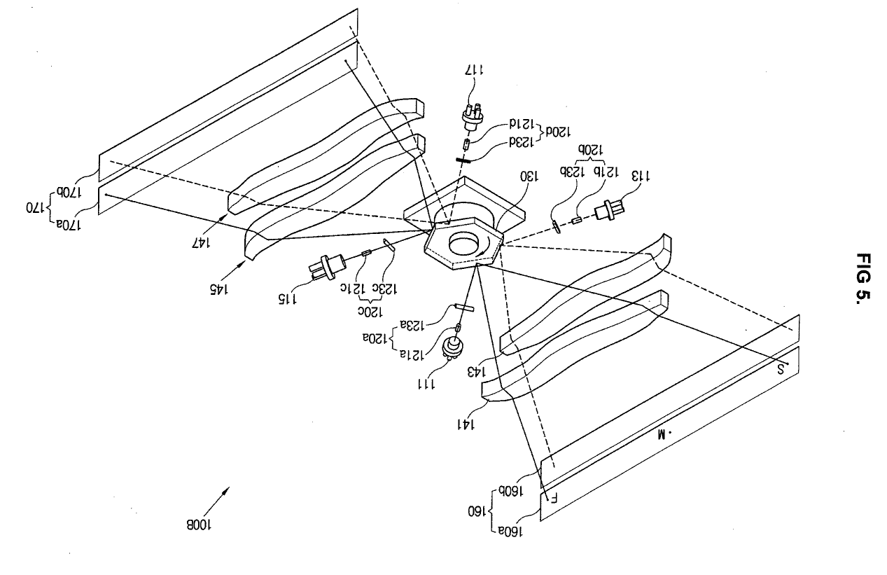

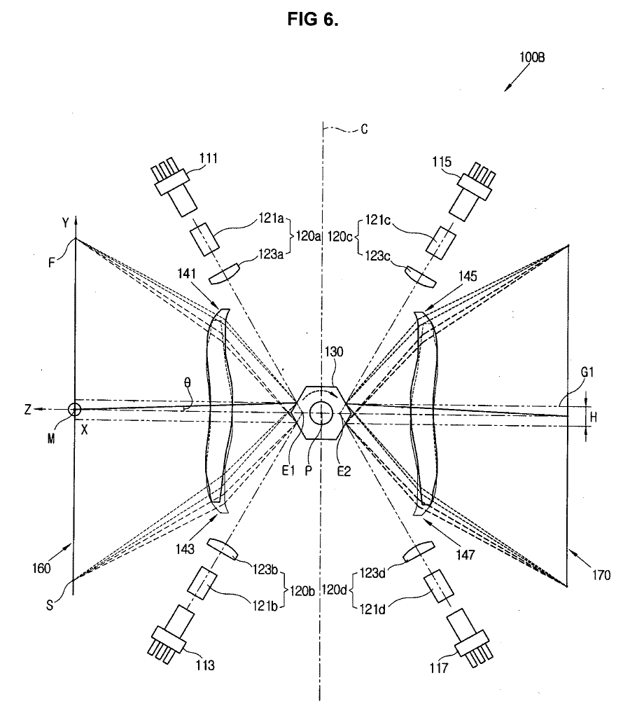

Further, as shown in FIGS. 5 and 6, another embodiment of the general inventive concept further contains a third light source 115 and a fourth light source 117 scanning a third laser and a fourth laser, respectively, symmetrical with the first laser and the second laser onto the reflecting faces of the polygon mirror 130, and a third F-θ lens 145 and a fourth F-θ lens 147 which are positioned between the polygon mirror 130 and an additional image forming part 170 facing the image forming part 160 across the polygon mirror 130 to form images corresponding to the respective lasers reflected by the polygon mirror 130 on the additional image forming part 170.

The third light source 115 and the fourth light source 117 scan the third laser and the fourth laser, respectively, toward a target position E2 that is symmetrical about a center cross line (see C in FIG. 6) with a target position E1 for the first laser and the second laser.

The third laser is symmetrical with the first laser with respect to the centering cross line (see line C in FIG. 6), which passes the rotating axial line of the polygon mirror 130 (point P in FIG. 6 and is perpendicular to the plane of the figure) and is perpendicular to the center line (Z axis). Likewise, the fourth laser is symmetrical with the second laser with respect to the center cross line (line C in FIG. 6).

The third and the fourth F-θ lenses, 145 and 147, respectively, converge the third laser and the fourth laser onto the additional image forming part 170a and 170b so as to have a scanning range corresponding to the scanning range scanned onto the image forming part 160a by the first laser.

The third F-θ lens 145 has an optical characteristic symmetrical with the first F-θ lens 141 with respect to the center cross line (line C in FIG. 6). That is, the third F-θ lens 145 may be obtained by rotating the first F-θ lens 141 by 180 degrees with respect to the center cross line (line C in FIG. 6).

The fourth F-θ lens 147 has an optical characteristic symmetrical with the second F-θ lens 143 with respect to the center cross line (line C in FIG. 6). That is, the fourth F-θ lens 147 may be provided by rotating the second F-θ lens 143 by 180 degrees with respect to the center cross line (line C in FIG. 6).

Any of the third light source 115 or the fourth light source 117 may be provided as necessary, and any F-θ lens may operate, with appropriate placement, as one of the corresponding F-θ lenses.

The laser scanning unit so configured, in which the light sources 111, 113, 115 and 117 are positioned to scan lasers symmetrical with respect to the center line (Z axis) as shown in FIGS. 5 and 6, makes the opposite ends of the laser scanning range formed in the image forming part 160 and the additional image forming part 170 to coincide with each other in the main scanning direction.

Also, the second F-θ lens 143, the third F-θ lens 145, and the fourth F-θ lens 147 need not be separately designed and manufactured. Instead, the first F-θ lens 141 is designed, and manufactured as a plurality of lenses, to be used as the second through fourth F-θ lenses 143, 145, and 147, thereby reducing manufacturing costs.

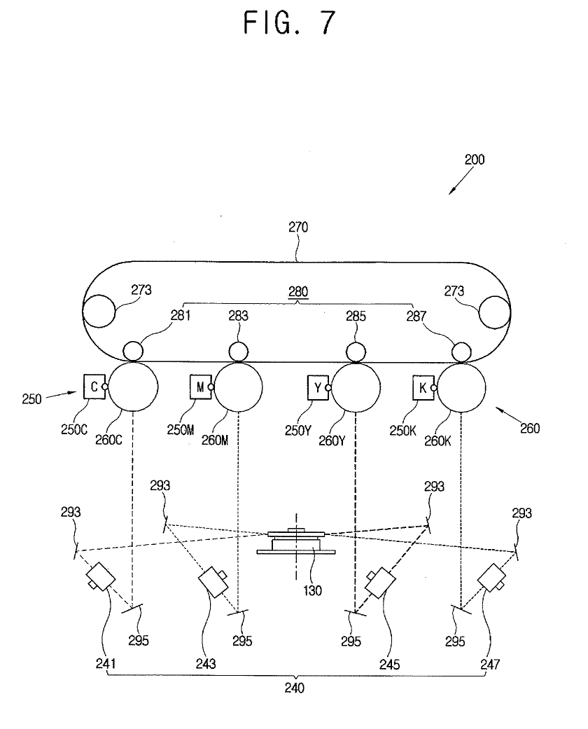

As shown in FIG. 7, an image forming apparatus 200 according to another embodiment of the present general inventive concept contains a plurality of photosensitive bodies 260 in which electrostatic latent images are formed, a plurality of light sources (not shown) scanning lasers to respectively expose the plurality of photosensitive bodies 260, a polygon mirror 130 reflecting the laser scanned from the plurality of light sources (not shown) onto the respective photosensitive bodies 260, and a plurality of F-θ lenses 240 positioned on the respective optical paths between the polygon mirror 130 and the plurality of photosensitive bodies 260 to correspond with opposite ends of a scanning range of the laser scanned to the respective photosensitive bodies.

The image forming apparatus 200 may further contain a plurality of developing units 250 provided to respectively supply predetermined colored toners to the surfaces of the plurality of photosensitive bodies 260, a transfer belt 270 to which toner on the surfaces of the plurality of photosensitive bodies 260 is transferred, a transfer operating roller 273 operating the transfer belt 270, a plurality of transfer roller 280 transferring the toners on the surfaces of the plurality of photosensitive bodies to the transfer belt 270 by electrostatic attraction, a paper transfer roller (not shown) transferring the colored toner image ultimately formed on the transferring belt 270 to a printing paper, and a fixing roller (not shown) fixing the colored toner image transferred on the printing paper by heat and pressure.

A colored image forming apparatus of a single-pass type using toner of YMCK colors as an example of the image forming apparatus 200 according to another embodiment of the present general inventive concept will be described in detail.

The light source (not shown) is accommodated inside the main body casing (not shown), and scans laser onto the polygon mirror 130 in a manner similar to the light sources 111, 113, 115, and 117 as described above. The light source (not shown) maybe provided as four laser diodes which correspond to the colors of YMCK, respectively, or any combination thereof.

The first through fourth light sources (not shown) containing the four laser diodes may scan lasers corresponding to image information of a cyan color, a magenta color, a yellow color, and a black color onto the polygon mirror 130. Then, the first through fourth photosensitive bodies 260C, 260M, 260Y, and 260K are exposed to the lasers reflected from the polygon mirror 130, respectively, to form electrostatic latent images on the surfaces thereon.

The plurality of F-θ lenses 240 correspond to the first through fourth F-θ lenses 241, 243, 245, and 247, respectively, similar to the F-θ lenses 141, 143, 145, and 147 of FIGS. 5-6.

The developing unit 250 attaches a predetermined colored toner to the electrostatic latent images formed on the surfaces of the photosensitive bodies 260. As shown in FIG. 7, the developing unit 250 is provided as a plurality of developing units 250C, 250M, 250Y, and 250K to supply colored toner corresponding to the first through fourth photosensitive bodies 260C, 260M, 260Y, and 260K in which electrostatic latent images corresponding to predetermined colors are formed.

The plurality of photosensitive bodies 260 are provided as the first through fourth photosensitive bodies 260C, 260M, 260Y, and 260K in which the electrostatic latent images corresponding to a cyan color, a magenta color, a yellow color, and a black color are formed. Of course, other colors or variations thereof may be used, according to design preference.

Toner images attached to the surfaces of the plurality of photosensitive bodies 260C, 260M, 260Y, and 260K are transferred to the transfer belt 270 by the transfer roller 280. The toner images of cyan, magenta, yellow and black, which are formed on the first through fourth photosensitive bodies 260C, 260M, 260Y, and 260K are transferred to the transfer belt 270 by the transfer rollers 281, 283, 285, and 287, and overlapped each other to form an ultimate colored toner image.

The transfer roller 280 transfers the toner image attached to the electrostatic latent images on the surfaces of the respective photosensitive bodies 260C, 260M, 260Y, and 260K to the transfer belt 270 by electrostatic attraction, for example.

As shown in FIG. 7, a plurality of reflection mirrors 293 and 295 are positioned in “front” of and “back” of each of the first through fourth F-θ lenses 241, 243, 245, and 247 to change the light path to a desired direction.

A paper transfer roller (not shown) transfers the ultimate colored toner image from the transfer belt 270 to the printing paper.

Hereinafter, an operating process of the colored image forming apparatus with the above-described configuration will be described.

In the case that the transfer belt 270 is operated counter-clockwise by the operating rollers 273, a first laser corresponding to the image information of a cyan color, for example, is first emitted from a first light source (not shown) and the emitted laser is changed into a converged laser by an optical lens (not shown). The converged laser is reflected onto the first F-θ lens 241 from the reflecting faces of the polygon mirror 130, and the reflected laser passes through the first F-θ lens 241 and the reflection mirrors 293 and 295 to be scanned onto the surface of the first photosensitive body 260C within a predetermined scanning range.

When the surface of the first photosensitive body 260C is exposed by the first laser and an electrostatic latent image corresponding to the image information of the cyan color is formed, toner of the cyan color is attached to the electrostatic latent image by the first developing unit 250C. Accordingly, a cyan colored toner image is formed on the surface of the first photosensitive body 260C.

Also, the cyan colored toner image formed in the first photosensitive body 260C is transferred to the transfer belt 270 by the transfer roller 281.

After a predetermined time after the cyan colored image information is exposed, a second laser corresponding to image information of the magenta color exits from the second light source (not shown), and passes through the polygon mirror 130, the second F-θ lens 243, and the corresponding reflection mirrors 293 and 295 to be scanned onto the surface of the second photosensitive body 260M. At this time, the scanning range of the laser scanned on the surface of the second photosensitive body 260M is positioned opposite to with the scanning range of the first laser for the first photosensitive body 260C.

An electrostatic latent image corresponding to the image information of the magenta color is formed on the surface of the second photosensitive body 260M exposed by the second laser, and the magenta-colored toner of a second developing unit 250M is attached to the electrostatic latent image of the second photosensitive body 260M by electrostatic attraction. Accordingly, on the surface of the second photosensitive body 260M is formed a magenta-colored toner image.

The magenta-colored toner image is transferred to the transfer belt 270 in which the cyan colored toner image has already been transferred by the transfer roller 283. It should be understood that a controller (not shown) controls the starting time for laser scanning of the light source, so that the magenta-colored toner image is transferred in the sub scanning direction to be matched with the cyan colored toner image pre-transferred to the transfer belt 270. The method for overlaying or matching colored toner images in the sub scanning direction is not discussed herein as it is well known technology.

In a similar manner, the yellow and black colored toner images are transferred to the transfer belt 270 and an ultimate colored image made up of YMCK colors is formed on the transfer belt 270. The colored toner image of the transfer belt 270 is transferred to a printing paper by the paper transfer roller (not shown), and a colored toner image transferred to a printing paper is fixed on the fixing roller (not shown), thereby forming a colored image on the printing paper.

Accordingly, although the respective colored toner images formed in the first through fourth photosensitive bodies 260C, 260M, 260Y, and 260K are overlapped with each other, they are not misaligned in the main scanning direction. Accordingly, the colored image which is formed by overlapping the respective colored toner images with one another is not distorted.

As is apparent from the above description, the laser scanning unit and the image forming apparatus having the laser scanning unit according to the present general inventive concept has numerous benefits, for example, a few of the benefits are described below.

First, a plurality of light sources and a plurality of image forming parts can be all positioned on one side, and the light source need not be limited in a specific position, thereby improving space efficiency. Accordingly, the laser scanning unit and the image forming apparatus can be compactly manufactured.

Second, because the F-θ lenses are similarly shaped, the F-θ lenses, for different sub images, need not be separately manufactured, thereby reducing manufacturing costs.

Third, because the F-θ lenses are similarly shaped, the assembly process can be simplified and the production can be standardized.

The general invention concept provides economic and size advantages over conventional laser scanning units. Accordingly, it should be appreciated that laser scanning units or implementations thereof, according to the general inventive concept described herein, may find use in printers, copiers, fax machines, and other forms of printing or duplication that are now known in the field as well as future developed systems.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A laser scanning unit comprising:
a rotatable polygon mirror with a plurality of reflecting faces to reflect an incident light onto an image forming part;
a first light source to scan a first laser onto the reflecting faces at a predetermined scanning angle with respect to a center line that passes through a rotating axial line of the polygon mirror and a predetermined reference position on the image forming part;
a second light source to scan a second laser onto the reflecting faces, the second laser being symmetrical to the first laser with respect to the center line;
a first F-θ lens positioned on a first optical path of the first laser between the image forming part and the polygon mirror; and
a second F-θ lens positioned on a second optical path of the second laser between the image forming part and the polygon mirror, the second F-θ lens having an optical characteristic symmetrical to the first F-θ with respect to the center line.

2. The laser scanning unit according to claim 1, wherein each scanning angle of the first laser and the second laser is an acute angle.

3. The laser scanning unit according to claim 2, wherein the first laser and the second laser are scanned onto a target position on the center line shifted at a predetermined distance from the rotating axial line toward the image forming part.

4. The laser scanning unit according to claim 3, wherein the first F-θ lens and the second F-θ lens are shifted a predetermined offset amount along a main scanning direction from the center line.

5. The laser scanning unit according to claim 4,
wherein the predetermined offset amount H is within the range of the following formula:
$$2 d tan ( θ ) ≦ H ≦ 2 r sin ( \frac{180}{n} )$$
where, “d” indicates a perpendicular distance between the lens center and the image forming part, “θ” indicates an angle between a line connecting a lens center with the reference position and the center line, “r” indicates an inscribed circle radius of the reflecting faces of the polygon mirror, and “n” indicates a number of the reflecting faces of the polygon mirror.

6. The laser scanning unit according to claim 1,
wherein the first laser and the second laser are displaced from each other along a direction of the rotating axial line and scanned onto the reflecting faces.

7. The laser scanning unit according to claim 2,
wherein the first laser and the second laser are displaced from each other along a direction of the rotating axial line and scanned onto the reflecting faces.

8. The laser scanning unit according to claim 1, further comprising:
an additional light source which is symmetrical with at least one of the first laser and the second laser with respect to the center line and scans at least one additional laser onto the reflecting faces, the additional light source being spaced from the at least one of the first laser and second laser along the rotating axial line; and
an additional F-θ lens which is positioned on an additional optical path between the image forming part and the polygon mirror, the additional F-θ lens has an optical characteristic symmetrical with the at least one of the first and second F-θ lens.

9. The laser scanning unit according to claim 1, further comprising:
an additional light source symmetrically positioned to at least one of the first light source and the second light source with respect to a center cross line which passes through the rotating axial line and is at a right angle to the center line; and
an additional F-θ lens positioned between the polygon mirror and another image forming part, the another image forming part being symmetrically positioned with the image forming part with respect to the center cross line, and the additional F-θ lens being arranged to be symmetrical with at least one of the first F-θ lens and the second F-θ lens with respect to the center cross line.

10. An image forming apparatus comprising:
an image forming part;
a rotatable polygon mirror with a plurality of reflecting faces to reflect an incident laser:
a first light source to scan a first laser onto the reflecting faces at a predetermined scanning angle with respect to a center line that connects a rotating axial line of the polygon mirror with a predetermined reference position of the image forming part;
a second light source to scan a second laser onto the reflecting faces, the second laser being symmetrical to the first laser with respect to the center line;
a first F-θ lens positioned on a first optical path of the first laser between the image forming part and the polygon mirror; and
a second F-θ lens positioned on a second optical path of the second laser between the image forming part and the polygon mirror, the second F-θ lens having an optical characteristic that is symmetrical with the first F-θ lens with respect to the center line.

11. The image forming apparatus according to claim 10, wherein the first laser and the second laser are scanned onto a target position which is shifted a predetermined distance from the axial line to the image forming part and is on the center line.

12. The image forming apparatus according to claim 10, wherein the first F-θ lens and the second F-θ lens are shifted a predetermined offset amount along a main scanning distance from the center line.

13. The image forming apparatus according to claim 11, wherein the first F-θ lens and the second F-θ lens are shifted a predetermined offset amount along a main scanning distance from the center line.

14. The image forming apparatus according to claim 12, wherein the predetermined offset amount (H) is within the range of the following formula:
$$2 d tan ( θ ) ≦ H ≦ 2 r sin ( \frac{180}{n} )$$
where, “d” indicates a perpendicular distance between the lens center and the image forming part, “θ” indicates an angle between a line connecting a lens center with the reference position and the center line, “r” indicates an inscribed circle radius of the reflecting faces of the polygon mirror, and “n” indicates a number of the reflecting faces of the polygon mirror.

15. The image forming apparatus according to claim 13, wherein the predetermined offset amount H is within the range of the following formula:
$$2 d tan ( θ ) ≦ H ≦ 2 r sin ( \frac{180}{n} )$$
where, “d” indicates a perpendicular distance between the lens center and the image forming part, “θ” indicates an angle between a line connecting a lens center with the reference position and the center line, “r” indicates an inscribed circle radius of the reflecting faces of the polygon mirror, and “n” indicates a number of the reflecting faces of the polygon mirror.

16. The image forming apparatus according to claim 10, further comprising:
another image forming part positioned to be symmetrical with the image forming part with respect to a center cross line which passes through the rotating axial line and is at a right angle to the center line;
an another light source positioned to be symmetrical with at least one of the first light source and the second light source with respect to the center cross line; and
an another F-θ lens positioned between the another image forming part and the polygon mirror, and symmetrical with at least one of the first F-θ lens and the second F-θ lens with respect to the center cross line.

17. A laser scanning unit comprising:
a rotatable polygon mirror with a plurality of reflecting faces to reflect an incident light onto at least one image forming part;
at least one pair of light sources each corresponding to a respective image forming part to scan a pair of lasers onto the reflecting faces symmetrically to each other with respect to a center line extending between a rotating axial line of the polygon mirror and a predetermined reference position on a respective one of the image forming parts; and
a pair of F-θ lenses corresponding to each pair of light sources, each F-θ lens being disposed along an optical path of a corresponding laser of the pair of lasers between the corresponding respective image forming part and the polygon mirror.

18. The laser scanning unit according to claim 17, wherein each pair of F-θ lenses are shifted a predetermined offset amount along a main scanning direction from the center line.

19. The laser scanning unit according to claim 18, wherein
the at least one pair of light sources comprises two pairs of light sources, the first pair of light sources being disposed symmetrically to the second pair with respect to a line extending perpendicular to the center line, and
the pair of F-θ lenses comprises two pairs of pair of F-θ lenses, each pair corresponding with a respective pair of light sources.
